(19) United States
(12) Patent Application Publication
(10) Pub. No.: US 2013/0233185 A1
(43) Pub. Date: Sep. 12, 2013

(54) FOOD DEHYDRATOR DEVICE

(71) Applicants: Ronald Eugene Hunt, Georgetown, TX (US); Donnie Lee Miller, Austin, TX (US); Verlon Eugene Whitehead, Austin, TX (US)

(72) Inventors: Ronald Eugene Hunt, Georgetown, TX (US); Donnie Lee Miller, Austin, TX (US); Verlon Eugene Whitehead, Austin, TX (US)

(73) Assignee: CD3 HOLDINGS, INC., Austin, TX (US)

(21) Appl. No.: 13/417,063

(22) Filed: Mar. 9, 2012

(51) Int. Cl. A23L 3/40

(52) U.S. Cl. 99/476; 99/467

(57) ABSTRACT

The food dehydrator device is made of a top member, a bottom member, and a plurality of trays disposed there between. Each one of the trays comprise a support, upper and lower skirts disposed about a periphery of the support, and first and second opposing sides. The upper and lower skirts of adjacent support trays cooperate to form an enclosed side wall. First and second sets of posts are disposed along each one of the first and second opposing sides and in first and second arrangements, respectively. Adjacent trays may be actuated between first and second configurations by rotation of adjacent trays 90 degrees relative to one other. In the first configuration the first and second pairs of opposing sides of adjacent trays are aligned and in the second configuration, the first and second pairs of opposing sides of adjacent trays are offset by 90 degrees.

### FIELD OF THE INVENTION

The present invention relates to an improved device for dehydrating food, and more particularly, an improved device for dehydrating food items having a range of dimensions.

### BACKGROUND

Drying is a method of food preservation in which water is removed from the food. Bacteria, yeasts and molds need the water in the food to grow, and drying effectively prevents them from surviving in the food.

Open-air drying using sun and wind have been practiced since ancient times to preserve a variety of foods, but this method often takes a long time, exposes food to undesirable environmental elements, and does not produce consistent results.

Given the shortcomings of open-air drying, electric food dehydrators have gained in popularity. These devices speed the drying process and ensure more consistent results over the open-air drying technique. Because food items typically sought to be dehydrated are typically be sliced and arranged in a single layer, large surface areas are required for large quantities of food. It is desired, however, that such food dehydrator devices be as compact as possible so that they are suitable for use in a home kitchen and, at the same time, be able to accommodate food items of various dimensions. It is further desired to have a food dehydrator device in which the rate of dehydration may be adjusted to suit the type of food to be dehydrated.

There is, therefore, a need for a compact food dehydrator that permits the drying of large quantities of food of a variety of dimensions at a user-controllable rate.

### SUMMARY OF THE INVENTION

The preferred embodiments of food dehydrating devices disclosed herein provide a number of advantages over prior art devices, such as being compact in size and, at the same time, permitting control over the rate of drying of the food items, and accommodating food items having a range of dimensions.

In accordance with one preferred embodiment, a food dehydrator device is provided. The food dehydrator device comprises a top member, a bottom member, and a plurality of trays disposed between the top and bottom members. Each one of the trays comprise a support, upper and lower skirts disposed about a periphery of the support, and first and second opposing sides. The upper and lower skirts of adjacent support trays cooperate to form an enclosed side wall between the top and bottom members. A first set of posts is disposed along each one of the first opposing sides in a first arrangement and a second set of posts is disposed along each one of the second opposing sides in a second arrangement. Adjacent trays may be actuated between first and second configurations or positions by the rotation of adjacent trays relative to each other, e.g., in a preferred embodiment by a rotation of approximately 90 degrees. In the first configuration, the first and second pairs of opposing sides of adjacent trays are aligned, and wherein in the second configuration the first and second pairs of opposing sides of adjacent trays are offset by 90 degrees.

In accordance with a first aspect of the preferred embodiment, the first and second opposing sides are of equal lengths.

In accordance with a second aspect of the preferred embodiment, the posts of each one of the first and second set of posts protrude from both upper and lower sides of the tray.

In accordance with a third aspect of the preferred embodiment, the first set of posts comprises a first number of spaced posts.

In accordance with a fourth aspect of the preferred embodiment, the second set of posts comprises a second number of spaced posts different from the first number.

In accordance with a fifth aspect of the preferred embodiment, the first and second sets of posts are spaced in an alternating manner in the first and second arrangements, respectively.

In accordance with a sixth aspect of the preferred embodiment, the first set of posts comprises an odd number of posts, and wherein the second set of posts comprises an even number of posts.

In accordance with a seventh aspect of the preferred embodiment, one of the upper or lower skirts is disposed at a peripheral edge of the support, and the other one of the upper or lower support is disposed at a distance inward of the peripheral edge of the support.

In accordance with a eighth aspect of the preferred embodiment, a maximum distance between adjacent trays is provided in the first configuration, and a minimum distance between adjacent trays is provided in the second configuration.

In accordance with another preferred embodiment, a food dehydrator device is provided, the device comprising a chamber defined by a top portion, a bottom portion and peripheral side walls. A plurality of gas-permeable supports is disposed within the vented chamber, the supports each comprising a peripheral edge having a pair of opposing sides. A first set of distance members is disposed on at least a first side of the peripheral edge in a first arrangement, and a second set of distance members is disposed on at least a second side of the peripheral edge in a second arrangement different from the first arrangement. The first and second distance members cooperate to provide first and second distances by a 90 degree rotation of adjacent supports.

In accordance with a first aspect of the preferred embodiment, the food dehydrator device further comprises a fan to generate an airflow through the vented chamber.

In accordance with a second aspect of the preferred embodiment, the food dehydrator device further comprises a heat source coupled to the fan.

In accordance with a third aspect of the preferred embodiment, the first and second set of distance members are disposed on both top and bottom sides of the peripheral edge.

In accordance with a fourth aspect of the preferred embodiment, an odd number of distance members is provided in the first arrangement.

In accordance with a fifth aspect of the preferred embodiment, an even number of distance members is provided in the second arrangement.

In accordance with a sixth aspect of the preferred embodiment, the distance between adjacent distance members is roughly equivalent in the first and second arrangements.

In accordance with a seventh aspect of the preferred embodiment, the chamber comprises one or more vents defining an opening to allow the airflow being generated by the fan to pass therethrough.

In accordance with an eighth aspect of the preferred embodiment, the food dehydrator device further comprises one or more shields configured to be actuated relative to the openings to control the size of the openings from being completely or partially open to completely closed.

In accordance with a ninth aspect of the preferred embodiment, the first pair of opposing sides have equal lengths, and wherein the second pair of opposing sides have equal lengths.

In accordance with a tenth aspect of the preferred embodiment, the food dehydrator device further comprises an actuating means for actuating the one or more shields.

In accordance with a further preferred embodiment, a food dehydrator device is provided. The device comprises a base, a lid and a plurality of support trays therebetween. The base comprises a centrally-disposed fan to generate an airflow. The lid comprises one or more vents defining an opening to allow the airflow being generated by the fan to pass therethrough. The lid further comprises one or more shields configured to be actuated relative to the openings to control the size of the openings from being completely or partially open to completely closed.

The support trays each have top and bottom surfaces, a support grid, upper and lower skirts disposed about a periphery of the support grid. The upper and lower skirts of adjacent support trays cooperate to provide an enclosed side wall between the base and the lid. The support trays also each comprise first and second pairs of opposing sides and a centrally-disposed aperture defining an air passageway.

A first set of posts is disposed along each side of the first pair of opposing sides of each support tray, the first set of posts being arranged in a first arrangement and being provided on the top and bottom surfaces of the support trays. A second set of posts is disposed along each side of the second pair of opposing sides of each support tray, the second set of posts being arranged in a second arrangement that is different from the first arrangement and being provided on the top and bottom surfaces of the support trays. A central air passage is defined between the fan and the lid by the centrally-disposed aperture of the plurality of trays.

Adjacent trays may be stacked in one of a first or a second configuration or position providing a maximum or a minimum distance between adjacent trays, respectively. In the first configuration, at least one of the first or second posts of one tray is placed on top of the first or second posts of an adjacent tray, respectively, to provide the maximum distance between adjacent support trays. In the second configuration, both the first and second set of posts of adjacent trays are disposed alongside one another to provide the minimum distance between adjacent support trays. Adjacent trays may be actuated between the first and second configuration by a rotation of adjacent trays relative to each other, e.g., a 90 degree rotation.

Other objects, features and advantages of the present invention will become apparent to those skilled in the art from the following detailed description.

### BRIEF DESCRIPTION OF THE DRAWINGS

These and other features and advantages of the present invention will be appreciated as the same becomes better understood by reference to the following detailed description when considered in connection with the accompanying drawings wherein:

FIG. 1 is a perspective view of an embodiment of the dehydrating device in a first configuration;

FIG. 2 is a front elevation view of the dehydrating device of FIG. 1;

FIG. 3 is a top elevation view of the dehydrating device;

FIG. 4 is a top perspective view of a food tray;

FIG. 5 is a bottom perspective view of the food tray of FIG. 4;

FIG. 6A is a front elevation view of one side of the dehydrating device of FIG. 1 with the facing external ribs removed to show the location of the three tray posts;

FIG. 6B is a front elevation view of the side of the dehydrating device of FIG. 1 that is adjacent to the side shown in FIG. 6A, also with the facing external ribs removed to show the location of the two tray posts;

FIG. 7A is a perspective cross-sectional view of the dehydrating device taken along 7-7 of FIG. 3 in a first configuration;

FIG. 7B is the same cross-sectional view of FIG. 7A showing the dehydrating device without the lid in a first configuration;

FIG. 7C is a cross-sectional view of the dehydrating device taken along 7-7 of FIG. 3 in a first configuration;

FIG. 8 is a cross-sectional view of the dehydrating device taken along 8-8 of FIG. 3 in a second configuration;

FIG. 9A is a cross-sectional view of the dehydrating device taken through a side portion of the device in FIG. 3 in a second configuration; and

FIG. 9B is a cross-sectional view of the dehydrating device taken through a side portion of the device in FIG. 3 in a second configuration.

Like numerals refer to like parts throughout the several views of the drawings.

### DETAILED DESCRIPTION

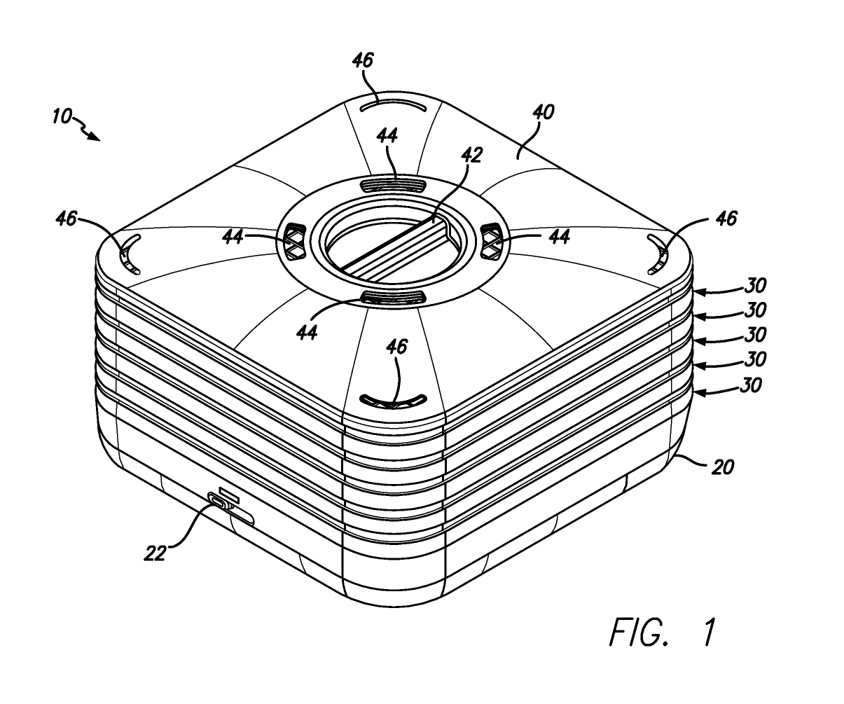

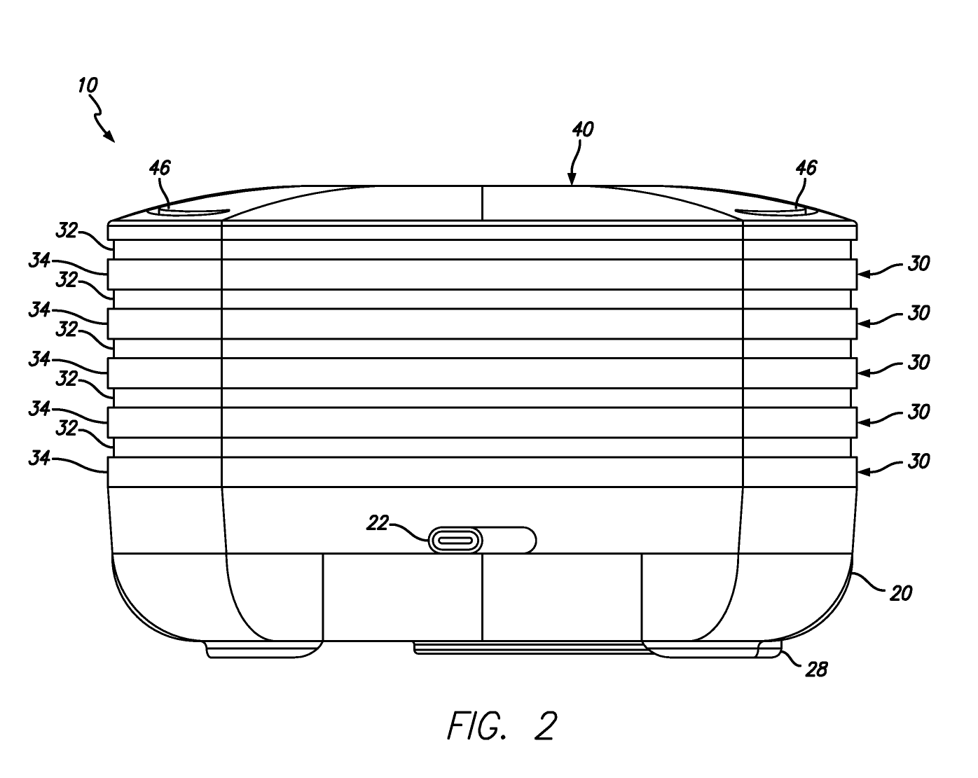

In FIGS. 1 and 2 a fully-assembled food dehydrator device 10 is depicted as comprising a lid 40, a base 20 and a plurality of trays 30 provided in a stacked relation between the lid 40 and the base 20.

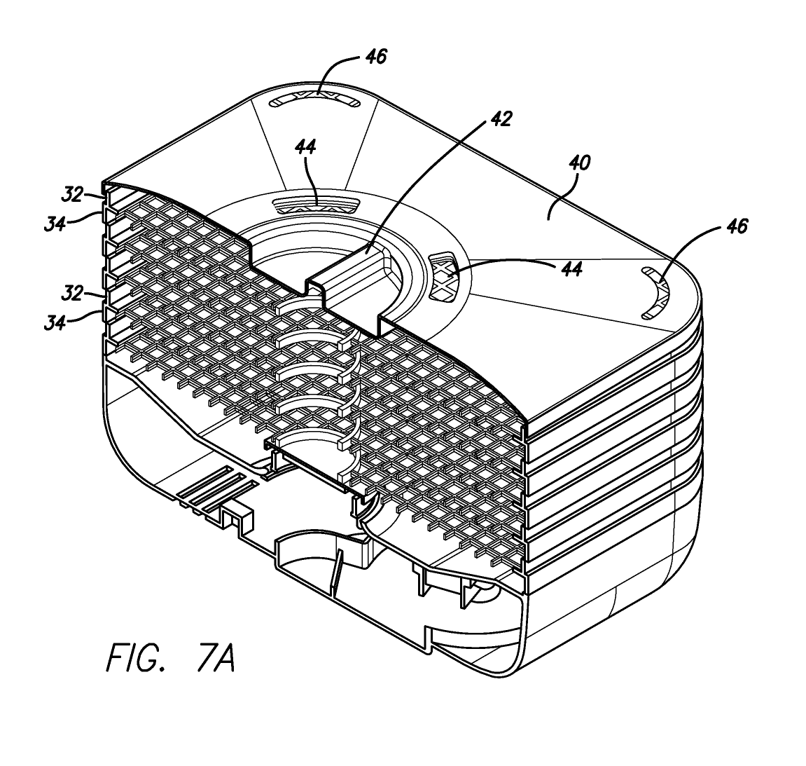

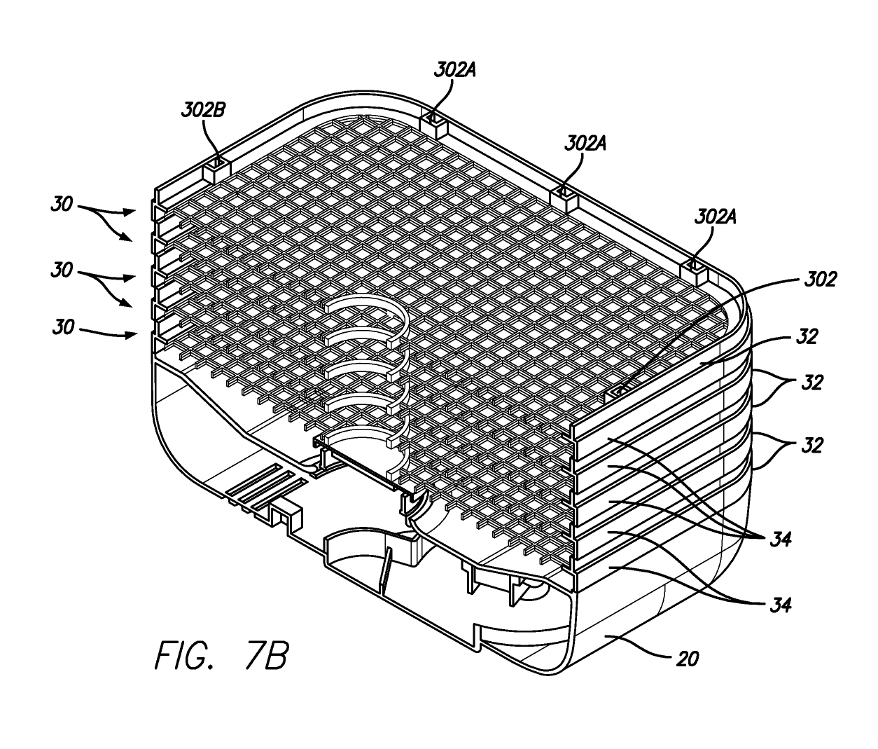

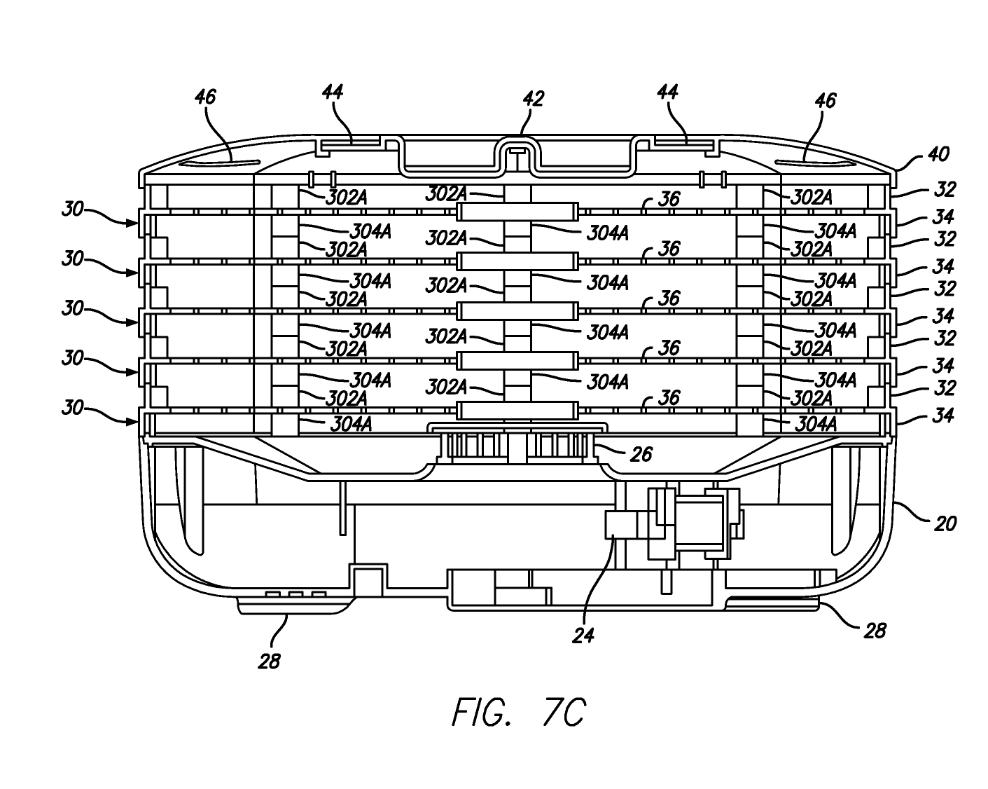

The base 20 is provided with a power switch 22 and, as shown in greater detail in FIG. 7C, the base 20 comprises a fan 26 coupled to a motor and heat source 24. The fan 26 is configured to generate airflow through the plurality of trays 30. The base 20 may optionally comprise footings 28 to stabilize the base 20 on top of a counter top or other working surface.

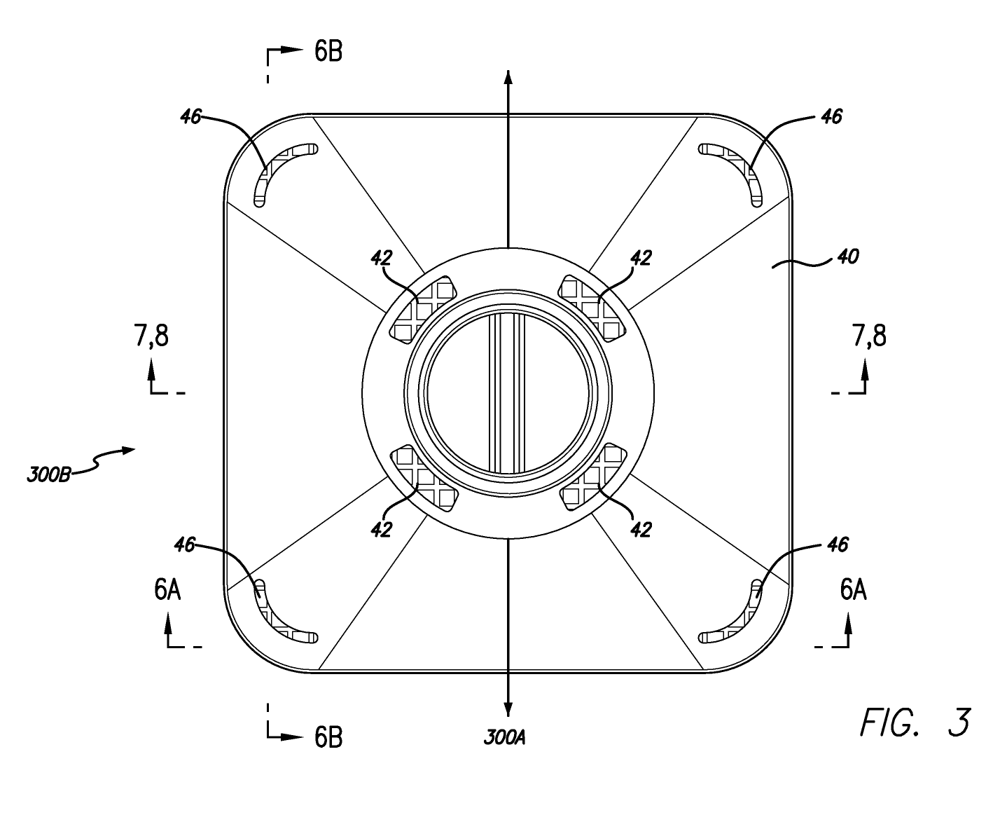

The lid 40 is depicted in FIGS. 1 and 3 as comprising a plurality of vents 44, 46 configured to allow the airflow generated by the fan to exit the device 10. An actuator 42 may be provided to actuate one or a plurality of shields disposed below the lid (not shown) to control the vent openings 44 in a range positions from being completely open to completely closed. FIGS. 1 and 3 depict the vent opening 44 as being completely open. It is understood that the rate of dehydration may be controlled by extent of venting provided to the device 10, as well as the rate of airflow through the device 10, and the amount of heat applied.

A plurality of trays 30 are stacked between the base 20 and the lid 40. Although the figures show the device 10 as having 5 trays 30, it is understood that any number of trays may be utilized in the device 10. In a preferred embodiment, the trays 30 are dimensioned identically, preferably as polygons having pairs of opposing sides and, even more preferably, as a square.

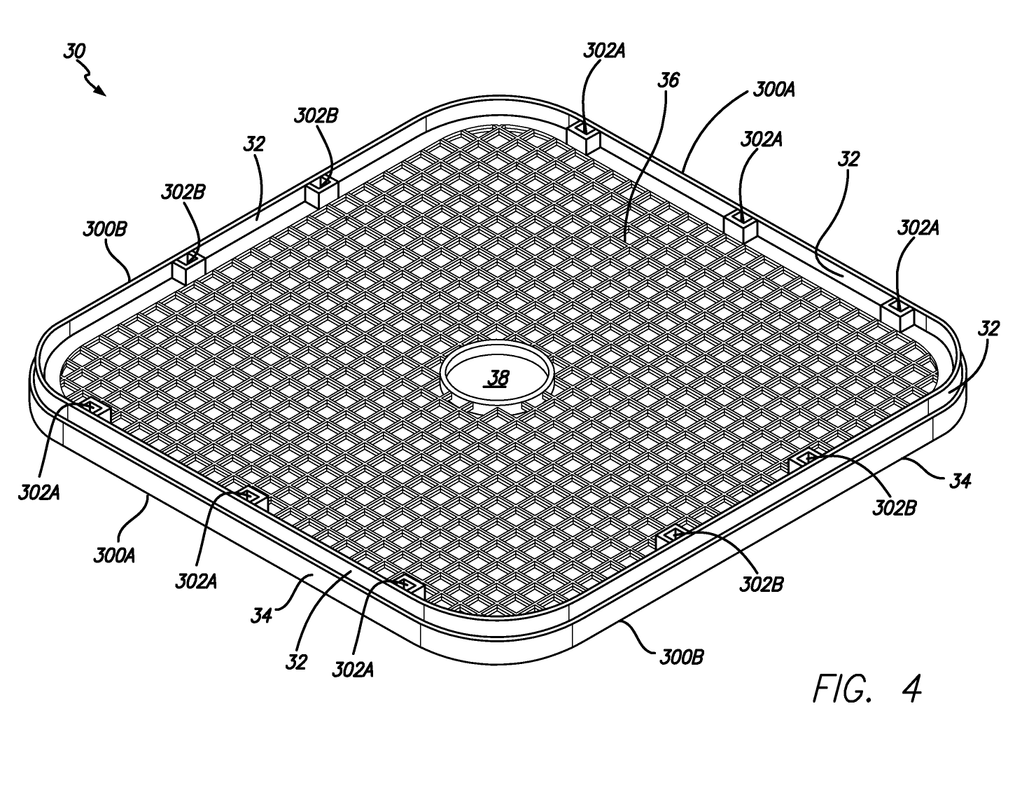

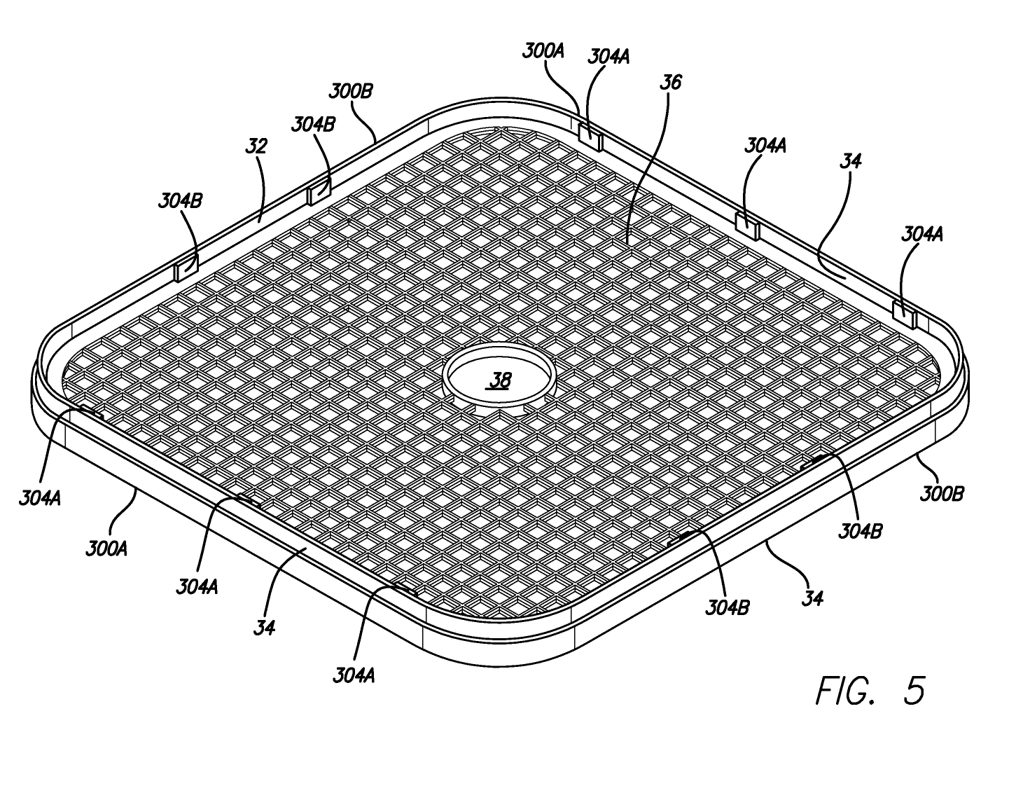

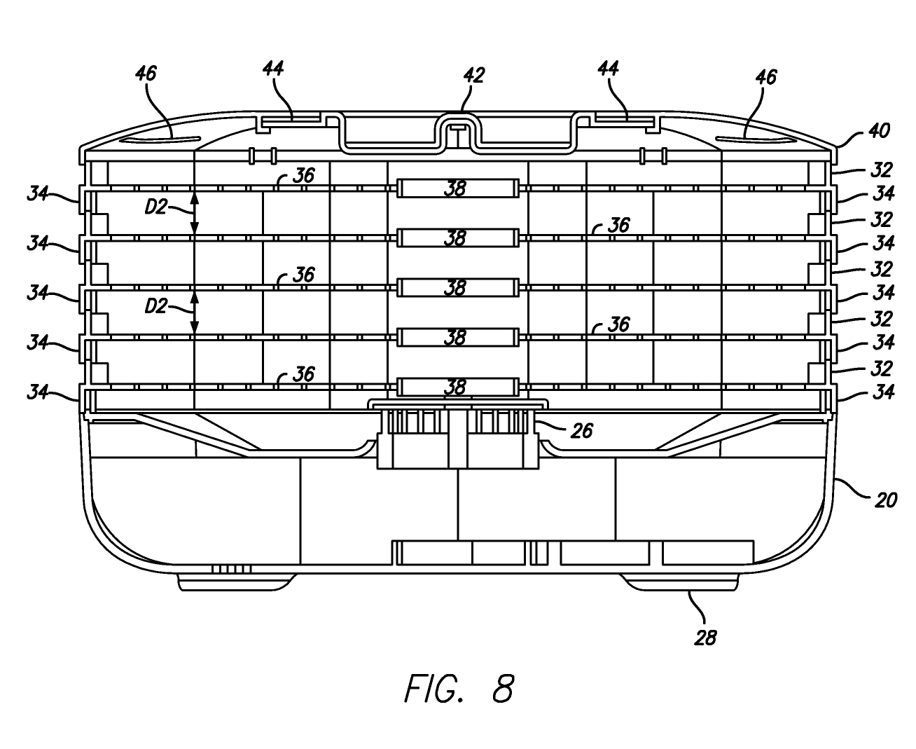

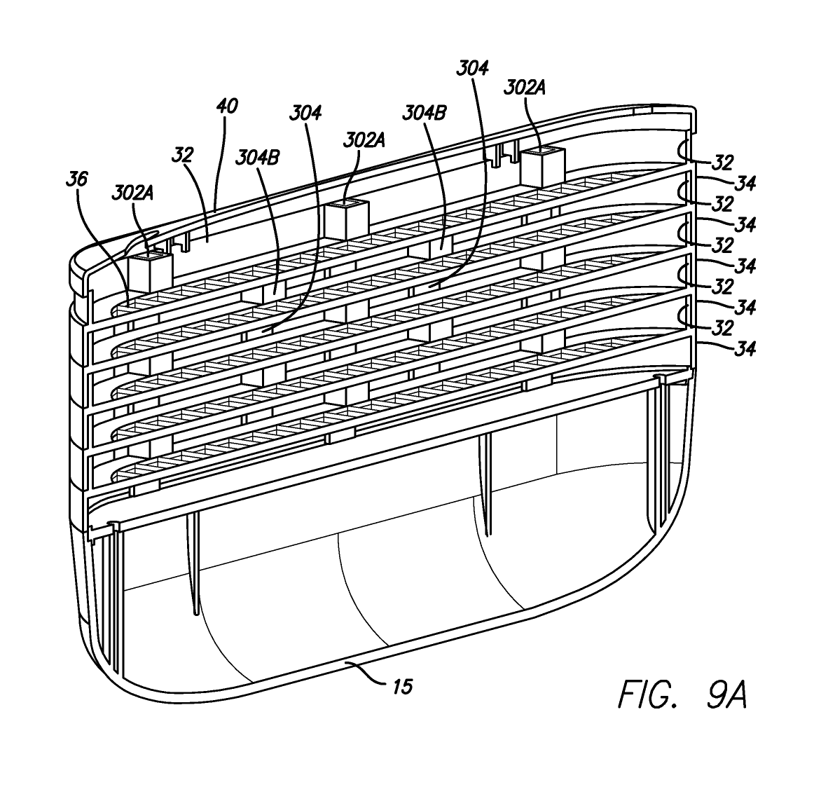

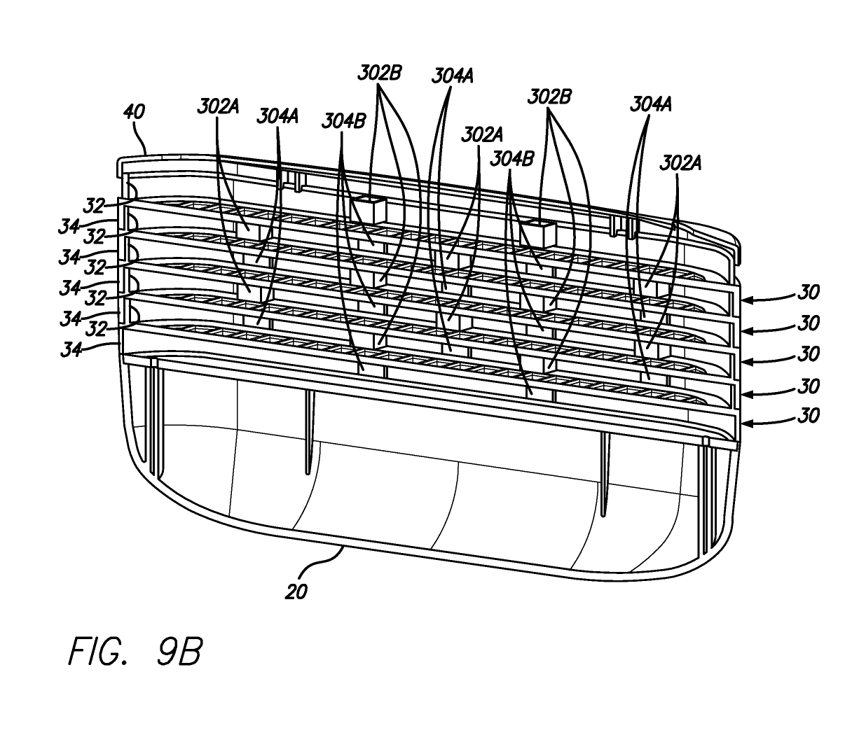

FIGS. 4 and 5 depict an embodiment of a square-shaped tray 30 as comprising a grid 36 having a central aperture and upper and lower skirts 32, 34 along its periphery. The upper skirt 32 is shown as being stepped inward of the lower skirt 34. This configuration permits the upper and lower skirts 32, 34 to cooperate and provide an enclosed side wall, while at the same time permitting the spacing between adjacent trays 30 to be adjusted between a first maximum distance (d1) and a second minimum distance (d2), as shown in FIGS. 7C and 9B, respectively. When adjacent trays 30 are spaced at a first maximum distance (d1), both the upper and lower skirts 32, 34 form the external side wall of the device 10 (FIGS. 2, 6A-6B, 7A-7C). In contrast, when adjacent trays 30 are spaced at a second minimum distance (d2), only the lower skirt 34 form the external side wall of the device 10 (FIGS. 8, 9A-9B).

The tray 30 further comprises first and second pairs of opposing sides 300A, 300B. A first set of posts 302A, 304A is provided along each of the first pair of opposing sides in a first configuration, and a second set of posts 302B, 304B is provided along each of the second pair of opposing sides in a second configuration. In the first configuration, the three posts 302A, 304A are provided as being equally spaced relative to one another and in the second configuration, two posts 302B, 304B are provided, also as being equally spaced relative to one another.

The distance between the grids 36 of adjacent trays 30 are determined by the height of the posts 302A-B, 304A-B and their orientation with respect to adjacent trays 30.

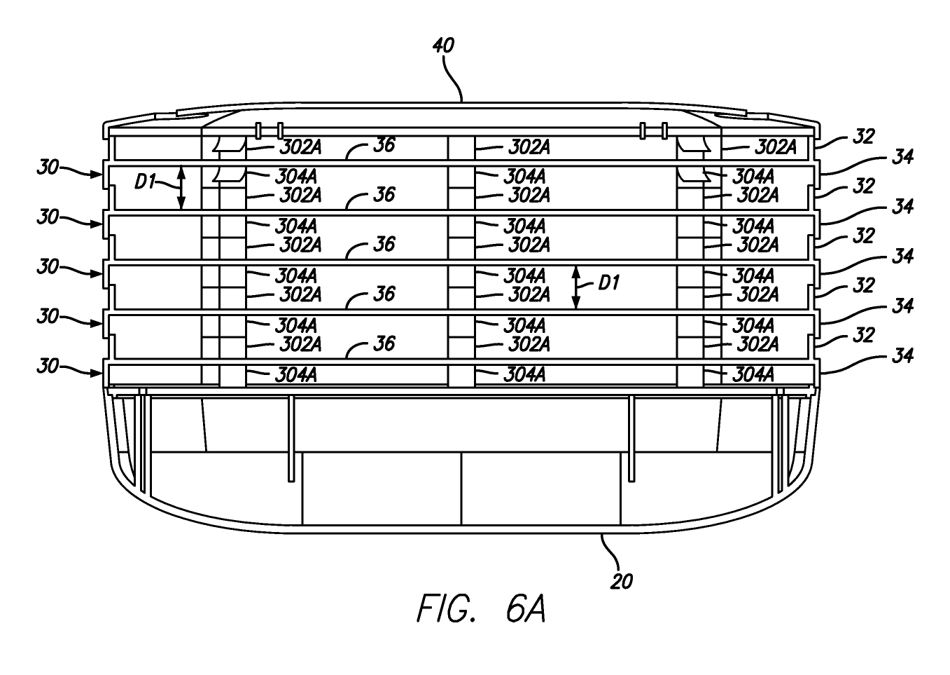

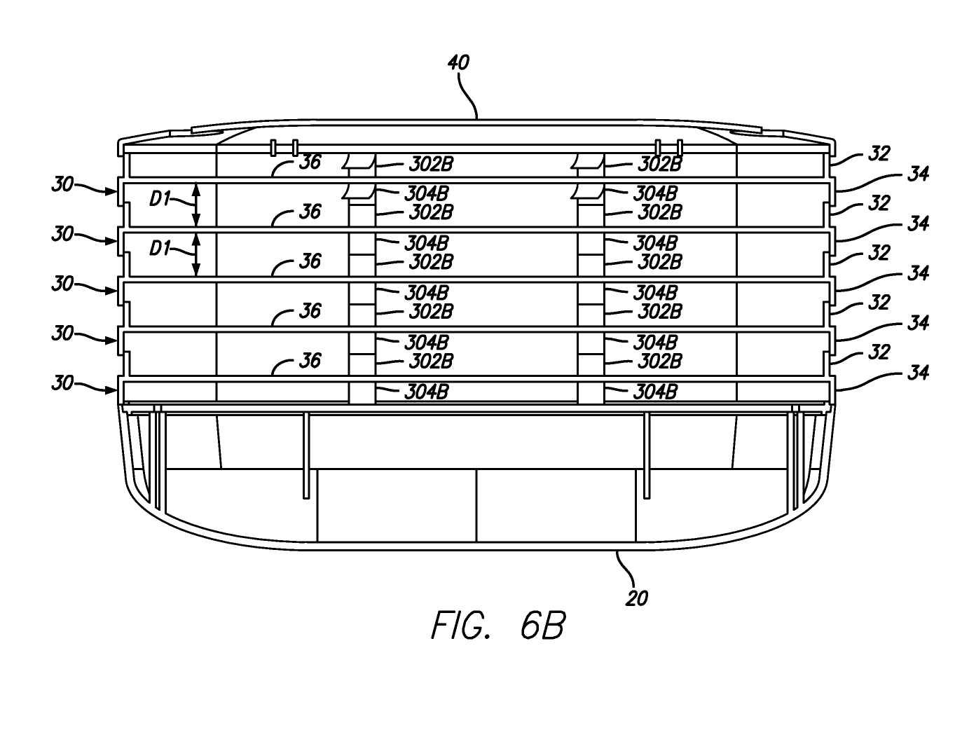

FIGS. 6A-B depict a maximum distance dl between adjacent grids 36 resulting from the alignment of posts 302A and 304A between adjacent grids 36 along the first pair of opposing sides 300A as well as the alignment of posts 302B and 304B between adjacent grids along the second pair of opposing sides 300B. The maximum distance d1 shown in FIGS. 6A-B therefore corresponds to the larger one of the sum of the heights of the posts 302A and 304A and of the posts 302B and 304B.

FIGS. 8 and 9A-B depict a minimum distance d2 between adjacent grids 36 resulting from rotating alternating grids at a 90 degree angle. Because the first and second configuration of the posts, as provided on the first and second opposing sides, are provided in different spaced relationship, there is no alignment of posts between adjacent grids 36 and rather each one the posts 302A, 304A, 302B, 304B do not abut one another but rather directly contacts the grid 36 or a peripheral area of the tray 30 that is roughly coplanar with the grid 36. In accordance with this embodiment, the minimum distance d2 corresponds to the height of the tallest single post.

The central apertures 38 of the stacked trays 30 provide an air passageway between the fan 26 and the plurality of vents 44, 46. The relative positions of the plurality of vents 44, 46 are significant in providing the ability to control the direction of air flow within the chamber of the device. For example, closing vents 44 by actuating the shields (not shown) to close the openings would result in the airflow impinging on the lid to recirculate outward and back downward from the lid. To that end, the lid may be configured to have a dome-like shape that directs the upwardly impinging air back downward onto the trays. Peripheral vents 46 may permit for the release of accumulating air pressure in the chamber of the device 10.

It is to be understood that the detailed description and specific examples, while indicating preferred embodiments of the present invention, are given by way of illustration and not limitation. Many changes and modifications within the scope of the present invention may be made without departing from the spirit thereof, and the invention includes all such modifications.

For example, while a particular embodiment of the food dehydrator has been described and illustrated having a configuration that provides first and second distances between the trays by rotating adjacent trays by 90 degrees, it is to be understood that food dehydrators constructed as disclosed herein may be configured having other polygonal orientations capable of providing such different distances between the trays by rotating in an amount other than 90 degrees, e.g., by rotating 60, 45, 30 degrees or the like.

What is claimed is:

1. A food dehydrator device comprising:
a top member;
a bottom member; and
a plurality of trays having first and second opposing sides disposed between the top and bottom members, the trays each comprising a support, upper and lower skirts disposed about a periphery of the support, the upper and lower skirts of adjacent support trays cooperating to form an enclosed side wall between the top and bottom members;
a first set of posts disposed along each one of the first opposing sides in a first arrangement;
a second set of posts disposed along each one of the second opposing sides in a second arrangement;
wherein adjacent trays are actuated between first and second configurations by rotation of adjacent trays 90 degrees relative to each other, wherein in the first configuration the first and second pairs of opposing sides of adjacent trays are aligned and wherein in the second configuration, the first and second pairs of opposing sides of adjacent trays are offset by 90 degrees.

2. The food dehydrator device of claim 1, wherein the first and second opposing sides are of equal lengths.

3. The food dehydrator device of claim 2, wherein the posts of each one of the first and second set of posts protrude from both upper and lower sides of the tray.

4. The food dehydrator device of claim 3, wherein the first set of posts comprises a first number spaced posts.

5. The food dehydrator device of claim 4, wherein the second set of posts comprises a second number of spaced posts different from the first number.

6. The food dehydrator device of claim 3, wherein in the first and second set of posts are spaced in an alternating matter in the first and second arrangements, respectively.

7. The food dehydrator device of claim 6, wherein the first set of posts comprises an odd number of posts, and wherein the second set of posts comprises an even number of posts.

8. The food dehydrator device of claim 1, wherein one of the upper or lower skirts is disposed at a peripheral edge of the support, and wherein the other one of the upper or lower support is disposed at a distance inward of the peripheral edge of the support.

9. The food dehydrator device of claim 1, wherein in the first configuration, a maximum distance between adjacent trays is provided and wherein in the second configuration, a minimum distance between adjacent trays is provided.

10. A food dehydrator device comprising:
a chamber defined by a top portion, a bottom portion and peripheral side walls;
a plurality of gas-permeable supports disposed within the vented chamber, the supports each comprising a peripheral edge having a pair of opposing sides;
a first set of distance members disposed on at least a first side of the peripheral edge in a first arrangement; and
a second set of distance members disposed on at least a second side of the peripheral edge in a second arrangement different from the first arrangement;
wherein the first and second distance members cooperate to provide first and second distances by a rotational movement of adjacent supports.

11. The food dehydrator device of claim 10 wherein the rotational movement is 90 degrees.

12. The food dehydrator device of claim 10 further comprising a fan to generate an airflow through the vented chamber.

13. The food dehydrator device of claim 12, further comprising a heat source coupled to the fan.

14. The food dehydrator device of claim 10, wherein the first and second set of distance members are disposed on both top and bottom sides of the peripheral edge.

15. The food dehydrator device of claim 10, wherein in the first arrangement, an odd number of distance members are provided.

16. The food dehydrator device of claim 15, where in the second arrangement, an even number of distance members are provided.

17. The food dehydrator of claim 16, wherein in the first and second arrangements, the distance between adjacent distance members are roughly equivalent.

18. The food dehydrator device of claim 10, wherein the chamber comprises one or more vents defining an opening to allow the airflow being generated by the fan to pass therethrough.

19. The food dehydrator device of claim 18, further comprising one or more shields configured to be actuated relative to the openings to control the size of the openings from being completely or partially open to completely closed.

20. The food dehydrator device of claim 19, further comprising an actuating means for actuating the one or more shields.

21. A food dehydrator device comprising:
a base comprising a centrally-disposed fan to generate an airflow;
a lid comprising one or more vents defining an opening to allow the airflow being generated by the fan to pass therethrough, the lid further comprising one or more shields configured to be actuated relative to the openings to control the size of the openings from being completely or partially open to completely closed;
a plurality of support trays having top and bottom surfaces and disposed between the base and the lid, the support trays each comprising a support grid, an upper skirt and a lower skirt disposed about a periphery of the support grid, the upper and lower skirts of adjacent support trays cooperating to provide an enclosed side wall between the base and the lid, the support trays also each comprising first and second pairs of opposing sides and a centrally-disposed aperture;
a first set of posts disposed on each side of the first pair of opposing sides of each support tray, the first set of post being arranged in a first arrangement and being provided on the top and bottom surfaces of the support trays;
a second set of posts disposed on each side of the second pair of opposing sides of each support tray, the second set of posts being arranged in a second arrangement that is different from the first arrangement and being provided on the top and bottom surfaces of the support trays;
wherein a central air passage is defined between the fan and the lid by the centrally-disposed aperture of the plurality of trays;
wherein adjacent trays may be stacked in one of a first or a second configuration providing a maximum or a minimum distance between adjacent trays, respectively;
wherein in the first configuration, at least one of the first or second posts of one tray is placed on top of the first or second posts of an adjacent tray, respectively, to provide the maximum distance between adjacent support trays;
wherein in the second configuration, both the first and second set of posts of adjacent trays are disposed alongside one another to provide the minimum distance between adjacent support trays; and
wherein adjacent trays may be actuated between the first and second configuration by a 90 degree rotation of adjacent trays relative to each other.
